(19) United States
(12) Patent Application Publication
(10) Pub. No.: US 2025/0022653 A1
(43) Pub. Date: Jan. 16, 2025

(54) MAGNETIC MATERIAL PREPARATION APPARATUS, MAGNETIC MATERIAL AND PREPARATION METHOD THEREOF, AND PREPARATION METHOD FOR NEODYMIUM-IRON-BORON MATERIAL

(71) Applicants: HANGZHOU DIANZI UNIVERSITY, Hangzhou (CN); ZHEJIANG ZECHEN INTELLIGENT EQUIPMENT CO., LTD., Huzhou (CN)

(72) Inventors: Xuefeng ZHANG, Hangzhou (CN); Lizhong ZHAO, Hangzhou (CN); Jianheng LI, Huzhou (CN)

(73) Assignees: HANGZHOU DIANZI UNIVERSITY, Hangzhou (CN); ZHEJIANG ZECHEN INTELLIGENT EQUIPMENT CO., LTD., Huzhou (CN)

(21) Appl. No.: 18/892,234

(22) Filed: Sep. 20, 2024

Related U.S. Application Data
(63) Continuation of application No. PCT/CN2023/138672, filed on Dec. 14, 2023.

(30) Foreign Application Priority Data
Dec. 14, 2022 (CN) 202211611402.6
Apr. 27, 2023 (CN) 202310467650.6
Apr. 27, 2023 (CN) 202320986889.X
Apr. 27, 2023 (CN) 202321005105.7
Apr. 27, 2023 (CN) 202321018394.4

(51) Int. Cl. H01F 41/02; H01F 7/02

(52) U.S. Cl. CPC H01F 41/0293; H01F 7/021

(57) ABSTRACT

A magnetic material preparation device, a magnetic material and a preparation method therefor, and a method for preparing a neodymium iron boron material are provided. The preparation device includes a coating device, a light curing device and a carrier. The magnetic material includes a magnet and a coating layer, at least part of a surface of the magnet is provided with the coating layer, the coating layer includes a diffusion material and a light curing material.

The method for preparing the magnetic material includes, coating a composite material containing the diffusion material and the light curing agent on at least part of the surface of the magnet, and performing a light curing treatment. The method for preparing the neodymium iron boron material includes performing diffusion material heat treatment for the neodymium-iron-boron magnet that a surface thereof is combined with a diffusion material and a light curing material.

### CROSS-REFERENCE TO RELATED APPLICATIONS

This application is a continuation of international patent application No. PCT/CN2023/138672, filed on Dec. 14, 2023, which itself claims priority to Chinese patent application Nos. 202211611402.6, filed on Dec. 14, 2022, and titled “A NEODYMIUM-IRON-BORON GRAIN BOUNDARY DIFFUSION METHOD BASED ON PHOTOPOLYMERIZATION RAPID PRINTING”, 202310467650.6, filed on Apr. 27, 2023, and titled “MAGNETIC MATERIAL PREPARATION DEVICE”, 202320986889.X, filed on Apr. 27, 2023, and titled “MAGNETIC MATERIAL PREPARATION DEVICE”, 202321005105.7, filed on Apr. 27, 2023, and titled “CURING DEVICE”, and 202321018394.4, filed on Apr. 27, 2023, and titled “COATING DEVICE”. The contents of the above identified applications are hereby incorporated herein in their entireties by reference.

### TECHNICAL FIELD

The present disclosure relates to the field of magnet preparation, and in particular, to a magnetic material preparation apparatus, a magnetic material and a preparation method thereof, and a method for preparing a neodymium-iron-boron material.

### BACKGROUND

Permanent magnets have wide range of applications in fields such as new energy, information communication, and intelligent manufacturing. Grain boundary diffusion can effectively improve the magnetic properties of permanent magnets. In the related technology, when the permanent magnet is prepared, a composite material containing diffusion material is coated on a surface of the permanent magnet. The permanent magnet with the composite material is then heated at a high temperature to cure the composite material, the cured composite material is combined with the permanent magnet. Finally, the permanent magnet with the composite material is performed a heat treatment, such that the diffusion material is diffused to grain boundary of the permanent magnet to improve magnetic properties of the permanent magnet.

### SUMMARY

According to various embodiments of the present disclosure, an apparatus for preparing a magnetic material apparatus is provided. The apparatus includes a coating device, a curing device and a carrier. The coating device includes a coating assembly, the coating assembly is configured to coat a composite material on at least part of a surface of a magnet, and the coating assembly has a coating region. The curing device includes a light source, the light source is configured to perform a light curing treatment on the composite material, the light source includes has an illumination region. The carrier is configured to carry the magnet. the apparatus can be in a first working state and a second working state, when the apparatus is in the first working state, at least part of the carrier is located in the coating region of the coating assembly and when the apparatus is in the second working state, at least part of the carrier is located in the illumination region of the light source.

In the present disclosure, the apparatus includes the curing device, the curing device includes the light source, and the light source is configured to perform the light curing treatment on the composite material. When the apparatus is in the second working state, at least part of the carrier is located within the illumination region of the light source to reduce a curing temperature of the composite material.

The present disclosure further provides a magnetic material. The magnetic material includes a magnet and a coating layer. The coating layer is disposed on at least part of a surface of the magnet. The coating layer includes a diffusion material and a light curing material, and the light curing material is processed by a light curing agent through a light curing treatment.

In the magnetic material of the present disclosure, the diffusion material is combined with the magnet via the light curing material, and the light curing material is cured by the light curing agent at a room temperature under a light condition, thereby reducing a temperature of combining the diffusion material and the magnet.

The present disclosure further provides a method for preparing a magnetic material. The method includes following steps:
providing a composite material and a magnet, wherein the composite material includes a diffusion material and a light curing agent;
coating the composite material on at least part of a surface of the magnet;
performing a light curing treatment on the composite material and forming a coating layer on at least part of the surface of the magnet, to obtain the magnetic material.

In the present disclosure, the diffusion material and the light curing agent are mixed to prepare the composite material, the composite material is combined with the magnet through the light curing treatment, i.e., the diffusion material is combined with the magnet to reduce the temperature of combining the diffusion material and the magnet.

The present disclosure further provides a method for preparing neodymium-iron-boron (NdFeB) magnet material. The method includes following steps:
step (1), processing a diffusion material containing heavy rare earth elements in a powder form;
step (2), grinding a surface of the NdFeB magnet by a sandpaper until a surface of the NdFeB magnet is smooth and removing oil and dirt;
step (3), mixing the diffusion material obtained in step (1) with a light curing agent uniformly in a certain mass ratio to obtain a mixture, feeding the mixture into the printer, and printing the mixture uniformly on the surface of the NdFeB magnet obtained in step (2); and
step (4), curing the NdFeB magnet obtained in step (3) under a light source to obtain the NdFeB magnet material, wherein the light source is near infrared light, ultraviolet light, or visible light, when the light source is near infrared light, upconversion nanoparticles are added to the light curing agent before curing, a curing time is in a range of 0.5 s to 300 s.

The present disclosure further provides a method for preparing NdFeB magnet material, the method includes following steps:
step (1), processing a diffusion material containing heavy rare earth elements in a powder form;
step (2), grinding a surface of an NdFeB magnet by a sandpaper until the surface of the NdFeB magnet is smooth, and removing oil and dirt;
step (3), mixing the diffusion material obtained in step (1) with a light curing agent uniformly in a certain mass ratio to obtain a mixture, feeding the mixture into a printer, and printing the mixture uniformly on the surface of the NdFeB magnet obtained in step (2);
step (4), curing the NdFeB magnet obtained in step (3) under a light source, wherein the light source is near infrared light, ultraviolet light, or visible light, when the light source is near infrared light, upconversion nanoparticles are added to the light curing agent before curing, a curing time is in a range of 0.5 s to 60 s; and
step (5), under a protective atmosphere of Ar, first maintaining the NdFeB magnet obtained in step (4) at 400°° C. to 500° C. for 5 min to 60 min, then performing a heat treatment at 750° C. to 1000° C. for 4 h to 10 h, and finally annealing at 400° C. to 600° C. for 2 h to 8 h, to obtain the NdFeB magnet material.

In the method preparing the neodymium-iron-boron (NdFeB) magnet material of the present disclosure, the light curing agent and the diffusion material are mixed to form the mixture in a certain ratio, and then the mixture coated on the NdFeB magnet is light-cured at a room temperature to reduce a curing temperature.

Details of one or more embodiments of the disclosure are presented in the attached drawings and descriptions below. And other features, purposes and advantages of this application will become apparent from the description and drawings.

### BRIEF DESCRIPTION OF THE DRAWINGS

For a better description and illustration of embodiments and/or examples of those disclosures disclosed herein, reference may be made to one or more attached drawings. Additional details or examples used to describe the drawings should not be considered as limiting the scope of any of the disclosed disclosures, currently described embodiments and/or examples, and currently understood best modes of these disclosures.

FIG. 1 is a front view of a coating device and a curing device of an apparatus for preparing a magnetic material in an embodiment of the present disclosure.

FIG. 2 is a schematic diagram of a coating device and a curing device of the present disclosure.

FIG. 3 is a partial enlargement view of portion A in FIG. 2.

FIG. 4 is a schematic diagram of a coating device of an apparatus for preparing a magnetic material in an embodiment of the present disclosure.

FIG. 5 is a schematic diagram of a base of an apparatus for preparing a magnetic material in an embodiment of the present disclosure.

FIG. 6 is a cross-section schematic view of a curing device of an apparatus for preparing a magnetic material in an embodiment of the present disclosure.

FIG. 7 is a schematic diagram of a curing device of an apparatus for preparing a magnetic material in an embodiment of the present disclosure.

FIG. 8 is a front view of an apparatus for preparing a magnet of the present disclosure.

FIG. 9 is a schematic diagram of a magnetic material of the present disclosure.

FIG. 10 is a flow diagram of a method for preparing a magnetic material of the present disclosure.

FIG. 11 is a flow diagram of a method for preparing NdFeB magnet material of the present disclosure.

FIG. 12 is a flow diagram of a method for preparing NdFeB magnet material of the present disclosure.

### DETAILED DESCRIPTION

The following will provide a clear and complete description of the technical solution in the embodiments of the present disclosure, in communication with the accompanying drawings. Obviously, the described embodiments are only a part of the embodiments of the present disclosure, not all of them. Based on the embodiments in the present disclosure, all other embodiments obtained by ordinary skill in the art without creative labor fall within the scope of protection of the present disclosure.

The permanent magnet is widely applied in fields such as new energy, information communication, and intelligent manufacturing. Grain boundary diffusion can effectively improve magnetic properties of permanent magnets. In the related technology, for preparing the permanent magnet, a composite material including a diffusion material is coated on a surface of the permanent magnet; then the permanent magnet with the composite material is heated at a high temperature to cure the composite material, and the cured composite material is combined with the permanent magnet; and finally the permanent being combined with the composite material is performed a heat treatment, such that the diffusion material is diffused to grain boundary of the permanent magnet to improve magnetic properties of the permanent magnet.

For example, an NdFeB magnet is a magnet of metal compound Nd₂Fe₁₄B, having advantages such as high saturation magnetization intensity, high uniaxial anisotropy, and so on. NdFeB grain boundary diffusion refers to a process of coating a surface of the magnet with a substance containing Dy, Tb, or other heavy rare earth elements, and then performing a heat treatment to make heavy rare earth atoms to diffuse along a liquid phase of grain boundary, resulting in a heavy rare earth diffusion source on a surface of the magnet and a grain boundary phase inside the magnet melting. This process can improve coercivity with a minimum content of heavy rare earth. Since reserves of heavy rare earth elements are small and expensive, a traditional alloying element addition method includes adding elements, mixing and melting all raw materials, and then processing such mixture in a powder form and sintering to obtain magnets. However, in the present disclosure, the grain boundary diffusion method can obtain high coercivity magnets with less heavy rare earth elements such as Dy and Tb, effectively reducing costs.

However, in the related technology, before the magnet treated by the grain boundary diffusion, a diffusion material is mixed with a heat curable agent to form a composite material; then a surface of the magnet is covered by the composite material; finally the magnet is heated and cured, such that the diffusion material is tightly combined on the surface of the magnet via a heat curable material. During a process of the grain boundary diffusion treatment, the diffusion material can be diffused to magnet grain boundary to improve magnetic properties of the magnet. In the related technology, a curing temperature of the composite material is high, i.e., a temperature of combining the diffusion and the magnet is high, thereby limiting a selection of the diffusion material, for example, some diffusion materials are prone to failure during the curing process due to oxidation of the diffusion materials. In other words, in the related technology, the diffusion technology has following problems: firstly, the diffusion material is prone to fire during a heating and curing process to cause the composite material to lose efficacy; secondly, the conventional method of coating the diffusion material and then performing a heating and curing treatment has disadvantages such as a long curing time and a complex procedure.

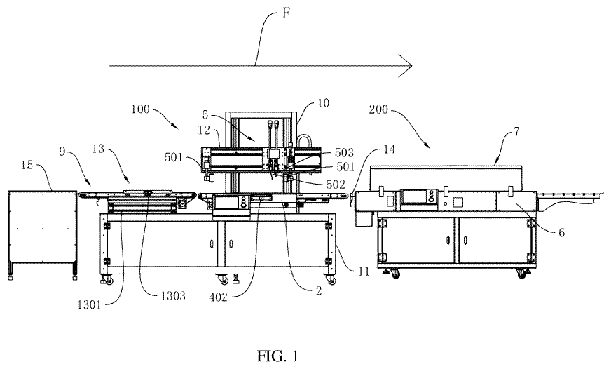

In the present disclosure, referring to FIGS. 1 to 8, the present disclosure provides an apparatus for preparing a magnetic material. The apparatus includes a coating device 100, a curing device 200 and a carrier 1. The coating device 100 includes a coating assembly 5. The coating assembly 5 is configured to coat a composite material on at least part of a surface of the magnet. The coating assembly 5 includes a coating region. The curing device includes light sources 704 and 708. The light sources 704 and 708 are configured to light-cure the composite material. The light sources 704 and 708 include an illumination region. The carrier 1 is configured to carry the magnet. The apparatus has a first working state and a second working state. When the apparatus is in the first working state, at least part of the carrier 1 is located in the coating region of the coating assembly; and when the apparatus is in the second working state, at least part of the carrier 1 is located in the illumination region of the light source, thereby, the light source is capable of performing the light curing treatment on the composite material located on the magnet, resulting in the composite material being combined with the magnet. The coating region of the coating assembly refers to a zone where the composite material can be coated in the apparatus when the coating assembly is in operation. For example, in a screen print process, the coating region of the coating assembly refers to an area where the coating assembly is capable of printing on a printing surface. The illumination region of the light source refers to a zone in the apparatus where an emitting light can reach when the light source is in operation. In the apparatus of the present disclosure, the curing device is a light curing device.

The curing device 200 can perform a light curing treatment for the composite material at a room temperature to reduce a curing temperature and decrease a risk of the composite material losing efficacy during a curing process. The light curing treatment is a process of hardening a substance by exposing it to a specific wavelength of light. In some embodiments of the present disclosure, the composite material includes a diffusion material, and the diffusion material is one or more of heavy rare earth hydrides, heavy rare earth fluorides, heavy rare earth oxides, heavy rare earths and alloys thereof. The curing device 200 merely uses a light source with a relatively low heat generation to cure the composite material, thereby reducing the diffusion material to be heated during a light curing process, and reducing a risk of the composite material losing efficacy due to a combustion of the diffusion material. The composite material containing the diffusion material is cured by the curing device 200 in the apparatus of the present disclosure, the composite material is combined with the magnet, the magnet with the composite material is performed a heat treatment, and the diffusion material can be diffused into the grain boundary of the permanent magnet. In some embodiments of the present disclosure, the magnet can be an NdFeB permanent magnetic or sintered NdFeB material.

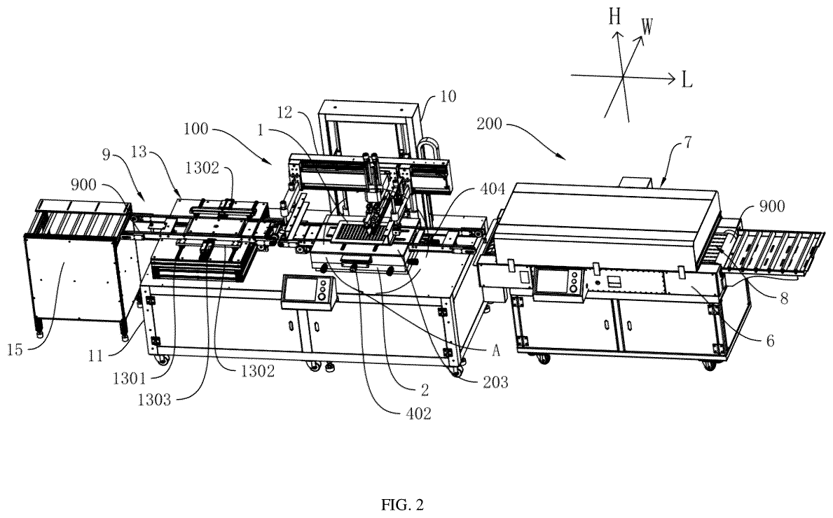

In some embodiments of the present disclosure, the apparatus includes a conveyor device 9. The conveyor device 9 includes a carrier 1 and a conveyor belt 900. The conveyor belt 900 is connected to the carrier 1. When the apparatus is in the first working state, at least part of the carrier 1 moves towards the coating assembly 5 relative to the conveyor belt 900. When the apparatus is in the second working state, at least part of the carrier 1 moves towards the light sources 704 and 708 relative to the conveyor belt 900. For example, as shown in FIGS. 2 to 4, When the apparatus is in the first working state, along a height direction H of the apparatus, at least part of the carrier 1 moves towards the coating assembly 5 relative to the conveyor belt 900. When the apparatus is in the second working state, along a height direction H, at least part of the carrier 1 moves towards the light sources 704 and 708 relative to the conveyor belt 900. In some embodiments of the present disclosure, at least part of the conveyor belt 900 is located within the coating device 100, and at least part of the conveyor belt 900 is located within the curing device 200.

When the magnet is prepared, the magnet is supported by the carrier 1 and conveyed to the coating device 100 by the conveyor device 9, a composite material containing the diffusion material is coated on a surface of the magnet by the coating device 100, the magnet is conveyed to the curing device 200 by the conveyor device 9. When the magnet enter into the illumination region of the light sources 704 and 708 in the curing device 200, a light emitted from the light sources 704 and 708 cures the composite material, thereby significantly reducing an energy waste of production.

It may occur a shark during a conveying process of the conveyor device 9, such that a position of the carrier 1 deviates from the conveying path and even it causes the carrier 1 to be detached from the conveyor device 9. If the carrier 1 is detached from the conveyor device 9, the magnet can not be further processed. Therefore, in some embodiments of the present disclosure, the apparatus includes a pre-positioning structure 13. The conveyor device 9 is configured to convey the carrier 1 to a position where the pre-positioning structure 13 is located and pre-position the carrier 1. On one hand, it can correct a position of the carrier 1, and on the other hand, it can reduce deviation of the carrier 1 relative to conveyor belt 900.

The pre-positioning structure 13 is a part of the apparatus, along a conveying path F, the pre-positioning structure 13 is located away from the curing device 200 relative to the coating device 100. This is, the carrier 1 can be pre-positioned before the carrier 1 enters to the coating device 100 and the curing device 200.

Referring to FIGS. 2 to 4, the pre-positioning structure 13 includes a carrier seat 1301 and at least two positioning portions 1302. The at least two positioning portions 1302 are connected to the carrier seat 1301. The at least two positioning portions 1302 protrude from the carrier seat 1301. The pre-positioning structure 13 further includes a drive structure 1303 configured to adjust the at least two positioning portions 1302, and at least one of the at least two positioning portions 1302 is connected to the drive structure 1303.

The conveyor belt 900 is configured to transport the carrier 1 between the two positioning portions 1302, and the drive structure 1303 drives one of the two positioning portions 1302 to correct the position of the carrier 1. During a correcting process, the positioning portion 1302 is in contact with the carrier 1 to finely adjust the position of the carrier 1. In another embodiment of the present disclosure, the pre-positioning structure 13 includes two drive structures 1303, the two drive structures 1303 can simultaneously drive the two positioning portions 1301 to correct the position of the carrier 1, which is more convenient and can improve an efficiency of the production. The drive structure 1303 is a linear motor or a screw structure driven by a motor.

After the position of the carrier 1 is adjusted, the conveyor belt 900 continuously transports the carrier 1 to the coating device 100 to coat, such that the diffusion material can be uniformly coated on a surface of the magnet, facilitating a subsequent light curing treatment. In particular, the composite material can be coated on at least part of the surface of the magnet by at least one method of printing, spraying, roller coating, and immersion coating. The coating device 100 can be a spraying device, the composite material containing the diffusion material can be uniformly coated on the surface of the magnet by an automated spraying method. Alternatively, the coating device 100 can be a printing device, and the composite material can be uniformly coated on the surface of the magnet by screen print.

In related technology, a coating device includes a base and a coating assembly. During a coating process, a carrier with a magnet to be coated is located on the base, and the coating assembly can process a coating treatment on the magnet. Since the carrier can not be accurately aligned with the coating assembly, and the composite material can not be accurately coated on the surface of the magnet to be coated. Therefore, it is required to improve the coating device.

In some embodiments of the present disclosure, the coating device is configured to coat the composite material on the surface of the magnet, a specific structure of the coating device includes a base 2 configured to support the carrier 1, a limiting assembly 3, a positioning assembly 4 and a coating assembly 5. The carrier 1 is configured to support a pre-coating object. The limiting assembly 3 and the positioning portion 4 are both connected to the base 2. There is a distance between the coating assembly 5 and the base 2. Referring to FIGS. 1 to 2, along a height direction H of the coating device, the coating assembly is located above the base 2. The positioning assembly 4 includes blocks 401, 403 and adjusting units 402, 404. The adjusting units 402, 404 are configured to adjust positions of the blocks 401, 403. The blocks 401, 403 are both slidably connected to the base 2. At least part of each of the blocks 401, 403 protrudes from the base 2. The limiting assembly 3 includes limiting portions 301, 302. The limiting portions 301, 302 are both fixed on or limitedly connected to the base 2. At least part of each of the limiting portions 301 and 302 protrudes from the base 2. The coating device includes a space configured to accommodate and support the carrier 1. The limiting portions 301, 302 and the blocks 401, 403 are located on two opposite sides of the space of the coating device, respectively.

When the carrier 1 is transported down the coating assembly 5, the limiting assembly 3 fits with the positioning assembly 4 to adjust a position of the carrier 1, such that the carrier 1 is aligned with the coating assembly 5. For example, the coating device has a coating state, when the coating device is at the coating state, along a length or width direction of the coating device, the blocks 401, 403 and the limiting portions 301, 302 are located on two sides of the carrier 1, respectively, and all of the limiting portions 301, 302 and the blocks 401, 403 abut against the carrier 1. In the present disclosure, when the coating device is at the coating state, the apparatus is in the first working state. In the present disclosure, a height direction H of the apparatus is the same as that of the curing device and that of the coating device, a width direction W of the apparatus is the same as that of the curing device and that of the coating device, and a length direction L of the apparatus is the same as that of the curing device and that of the coating device.

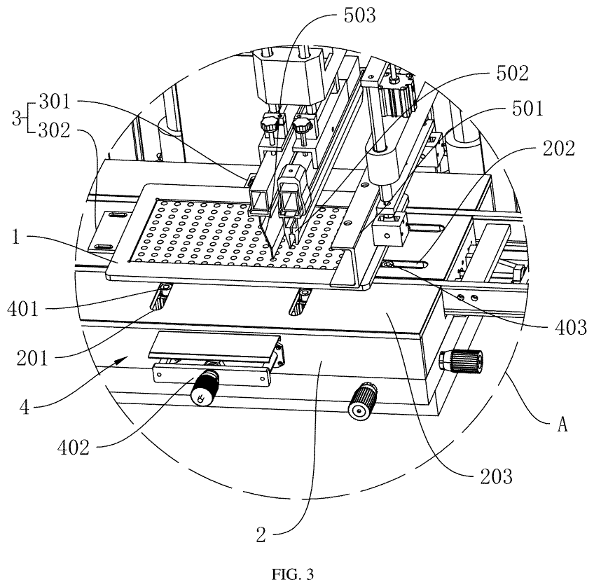

In particular, referring to FIGS. 3 and 5, the blocks 401, 403 can be denoted as a first block 401 and a second block 403. The adjusting units 402, 404 includes a first adjusting unit 402 configured to adjust a position of the first block 401 and a second adjusting unit 404 configured to adjust a position of the second block 403. The limiting portions 301 and 302 can be denoted as a first limiting portion 301 and a second limiting portion 302. When the apparatus is at the coating state, along a width direction W of the coating device, the first block 401 and the first limiting portion 301 are located on two sides of the carrier 1, respectively. Along the length direction L of the coating device, the second block 403 and the second limiting portion 302 are located on two opposite sides of the carrier 1, respectively. The first limiting portion 301 and the second limiting portion 302 are located on two adjacent sides of the carrier 1. The first limiting portion 301 is cooperated with the first block 401 and the second limiting portion 302 is cooperated with the second block 402 to limit a movement of the carrier 1 and reduce a deviation of the carrier 1 during a coating processing. The first adjusting unit 402 and the second adjusting unit 404 drives the first block 401 and the second block 403 respectively until the first block 401 and the second block 403 abut against the carrier 1, respectively, resulting in limiting the position of the carrier 1. On one hand, it can correct the deviation of the carrier 1, and on the other hand, it can reduce a movement of the carrier 1 during a process of coating the mixture.

In some embodiments of the present disclosure, the base 2 has a top surface 203. Along a height direction H of the coating device, a surface of the base 2 towards the coating assembly is denoted as the top surface 203. When the apparatus is at the coating state, at least part of the top surface 203 is in contact with the carrier 1. Along the height direction H of the coating device, at least part of the top surface 203 and the coating assembly 5 are located on two sides of the carrier 1, respectively. The base 2 supports the carrier 1 by the top surface 203. In some embodiments of the present disclosure, at least part of each of the limiting portions 301, 302 protrudes from the top surface 203, and at least part of each of the blocks 401, 403 protrudes from the top surface 203. The limiting portions 301 and 302 can be both integrated with the base 2 and protrude from the top surface 203. Alternatively, the limiting portions 301 and 302 can be a protrusion connected to the top surface 203.

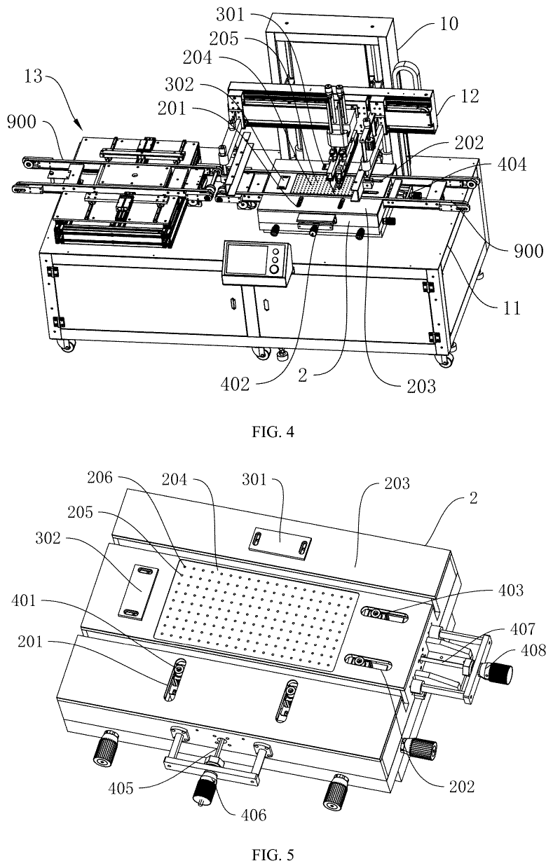

Referring to FIGS. 3 and 4, the base 2 includes chutes 201, 202. The chutes 201, 202 are recessed towards an inner part of the base 2 from the top surface 203, or the chutes 201, 202 penetrate through the top surface 203. At least part of each of the blocks 401, 403 is located on the chutes 201, 202, and at least part of each of the blocks 401, 403 protrudes from the top surface 203. Each of the adjusting units 402, 404 includes a connecting rod. The connecting rod is connected to the blocks 401, 403 and has an input end. The input end of the connecting rod is located outside the base 2. In particular, the first adjusting unit 402 includes a first connecting rod 405, the first connecting rod 405 includes a first input end 406, the second adjusting unit 404 includes a second connecting rod 407, and the second connecting rod 407 includes a second input end 408. The first connecting rod 405 and the second connecting rod 407 are rotatably connected to a sidewall of the base 2. The first connecting rod 405 is connected to the first block 401, and the second connecting rod 407 is connected to the second block 403. The chutes 201, 203 are denoted as a first chute 201 and a second chute 202, the first chute 201 is disposed along a width direction of the coating device, and the second chute 202 is disposed along a length direction of the coating device. The first block 401 is located on the first chute 201, and the second block 403 is located on the second chute 202. The first block 401 is slidably connected to a wall of the first chute 201, and the second block 403 is slidably connected to a wall of the second chute 202.

The base 2 mainly plays a role of supporting, and an inner part of the base 2 can be provided with other components. On one hand, at least part of the first adjusting unit 402 is disposed in the inner part of the base 2, thereby reduce a production space, and on the other hand, it prevents an affection from external environment. The first chute 201 provides with a space for the first chute 401 to move and plays a role of guiding the first block 401, such that the first block 401 can always move along the width direction of the coating device and push the carrier 1 to position and fix the carrier 1. In order to improve a stability during a process of pushing the carrier 1, the first chutes 201 can be set at least two, the first blocks 401 can be set corresponding to the first chutes 201, thereby uniformly pushing different positions of the carrier 1 and stably pushing the carrier 1.

Cooperation between the second adjusting unit 404 and the second block 403 is as same as that between the first adjusting unit 402 and the first block 401, which is configured to position and fix the carrier 1 on the other side of the carrier 1.

In some embodiments of the present disclosure, the limiting portions 301, 302 are in a plate shape, a column shape or an un-regular shape, alternatively, the limiting portions 301, 302 are not limited by above structures and can be an solid structure in other shapes, as long as it plays a role of hindering the carrier 1 during the coating process, and when the apparatus is at the coating state, the limiting portions 301, 302 are in line or surface contact with the carrier 1. The positioning assembly 4 includes at least two blocks 401 and 403, when the apparatus is at the coating state, along a length or width direction of the coating device, at least two blocks 401, 403 are located on a same side, and at least two blocks 401, 403 are in a line or surface contact with the carrier 1. Along the length or width direction of the coating device, at least two blocks 401, 403 is symmetrically arranged and have an axis of symmetry, and the limiting portions 301, 302 are symmetrical about the axis of symmetry. The blocks 401, 403 and the limiting portions 301, 302 are symmetrically arranged, on one hand, the carrier 1 can be stably pushed and move retrograde, and on the other hand, a stability of the carrier 1 when restricting the carrier 1 can be improved.

In some embodiments of the present disclosure, the adjusting units 402, 404 are one of a linear motor or a screw structure, and the linear motor or the screw structure can be configured to drive the blocks 401, 403. The linear motor and the screw structure are simple, which is conducive to installing and adjusting, resulting in a low cost.

In some embodiments of the present disclosure, the base 2 includes a hollow portion 204, and the hollow portion 204 includes a through hole 205 and a hole wall corresponding to the through hole 205. A plane perpendicular to the height direction of the apparatus is defined as a projection plane. Along the height direction of the apparatus, a font projection of the hollow portion on the projection plane is located within an outer contour of a front projection of the top surface on the projection plane. When the apparatus is at a first state, at least part of the carrier 1 is in contact with the top surface 203, along the height direction of the apparatus, the carrier 1 moves towards the coating assembly relative to the hollow portion 204. The through hole 205 is a blind hole, the through hole 205 is provided with an opening 206, and the opening 206 is located on the top surface 203. The through hole 205 is in communication with a suction pump, the suction pump is configured to suck out gas in the through hole 205. When the apparatus is at the coating state, along the height direction H of the coating device, a projection of the hollow portion 204 on the carrier 1 is located within an outer contour of the carrier 1.

When the apparatus is in the first working state, at least part of the top surface 203 of the base 2 is in contact with the carrier 1, and at least part of the top surface 203 is disposed opposite to the carrier 1. When the apparatus is in the first working state and the suction pump (not shown) is in operation, the suction pump is capable of enabling vacuum level inside perforation 205 is higher than the external environment of the apparatus, at least part of the carrier 1 is sucked by the hollow portion 204, and at least part of the carrier 1 is in contact with the top surface 203. The hollow portion 204 and the suction pump can fix the carrier 1 on the base 2. A movement of the carrier 1 during the coating process is reduced.

In some embodiments, referring to FIGS. 1 to 4, the coating device 100 includes a fixing seat 10 and a connecting seat 12. The fixing seat 10 includes a columnar structure parallel to the height direction of the coating device 100. The connecting seat 12 includes a columnar structure parallel to the width direction of the coating device 100. The coating assembly 5 is connected to the connecting seat 12. The connecting seat 12 is connected to the fixing seat 10. Along the length or width direction of the coating device 100, at least part of the coating assembly 5 and the base 2 are located in a same side of the fixing seat 10. The fixing seat 10 includes a first connecting portion and a second connecting portion. When the connecting seat 12 is connected to the first connecting portion, along the height direction H of the apparatus, a first distance is defined between the coating assembly 5 and the base 2; and when the connecting seat is connected to the second connecting portion, along the height direction H of the apparatus, a second distance is defined between the coating assembly 5 and the base 2. The first distance is not equal to the second distance, i.e., the first distance is greater than the second distance, or the first distance is less than the second distance. It means that the coating assembly 5 can be connected to different positions of the fixing seat 10 by the connecting seat 12, the coating assembly 5 of the present disclosure can adjust a distance between the coating assembly 5 and the carrier 1 or the base 2 along the height direction H of the coating assembly by the connecting seat 12.

In some embodiments of the present disclosure, the coating assembly 5 includes a screen frame 501, an ink-scraping blade 502 and an ink-returning blade 503, along the height direction H of the coating assembly 100, at least part of the ink-scraping blade 502 and at least part of the ink-returning blade 503 are located away from the base 2 relative to the screen frame 501. When the apparatus is at the coating state, along the height direction of the coating device, the screen frame 501 moves towards the carrier 1 relative to the ink-scraping blade 502 and the ink-returning blade 503, and at least part of at least one of the ink-scraping blade 502 and the ink-returning blade 503 is in contact with the screen frame 501.

In some embodiments of the present disclosure, the apparatus includes a supporting platform 11, the base 2 is connected to the supporting platform 11, and the fixing seat 10 is connected to the supporting platform 11. The screen frame 501, the ink-scraping blade 502 and the ink-returning blade 503 are all connected to the connecting seat 12. Along the height direction of the apparatus, at least part of the ink-scraping blade 502 and at least part of the ink-returning blade 503 are located above the screen frame 501.

The supporting platform 11 is provided a point position for connecting and installing the coating device 100, on a height direction of the fixing seat 10, the first connecting portion of the fixing seat 10 is defined as an upper half part of the fixing seat 10. When the coating device 100 is connected to the first connecting portion, the apparatus is at a holding state and not print the magnet, and at this time, the first distance is a distance between the carrier 1 and any one of the screen frame 501, the ink-scraping blade 502 and the ink-returning blade 503. The second connecting portion is a half bottom part of the fixing seat 10, when the coating device 100 is connected to the second connecting portion, at this time, the apparatus is in a working state, a wire mesh of the screen frame 501 covers on the surface of the magnet, the ink-scraping blade 502 and the ink-returning blade 503 prints the magnet. At this time, the second distance between the coating assembly 5 and the base 2 is a distance between the carrier 1 and any one of the screen frame 501, the ink-scraping blade 502 or the ink-returning blade 503. The first connecting portion and the second connecting portion move up and down and change with the connecting seat 12, when the connecting seat 12 moves from the first connecting portion to the second connecting portion, it means that the apparatus will be in the working state, and when the connecting seat 12 moves towards the first connecting portion from the second connecting portion, it means that the apparatus will be in the holding state.

In some embodiments of the present disclosure, along the height direction of the coating device, a projection of the screen frame 501 on the top surface 203 is located within the outer contour of the top surface 203. An area of the screen frame 501 limits a coating region or a coating area of the coating assembly 5, if the screen frame 501 is too large and out of a contour of the top surface 203, on one hand, it may cause a drop of the coating material to waste the material, and on the other hand, a size of the magnet is not excess the contour of the top surface 203, otherwise it may cause an instability of the carrier 1 during the coating process, and the carrier 1 moves around and affects the coating effect, resulting in incomplete coating.

In some embodiments of the present disclosure, along the conveying path of the conveyor belt 900, at least part of the conveyor belt 900 penetrates through the base 2, and the conveyor belt 900 gives way the hollow portion 204. When the apparatus is at a first state, along a height direction of the apparatus, the carrier 1 and the conveyor belt 900 are located on two sides of the top surface 203, respectively.

The conveyor belt 900 penetrates through the base 2, on one hand, the conveyor belt 900 will not affect coating for the magnet, the conveyor belt 900 is connected on a support, the support can moved up and down by a lift device. When the carrier 1 is transported, the conveyor belt 900 is lifted above the top surface 203 to prevent the limiting assembly 3 and the positioning assembly 4 from hindering a transport of the carrier 1. When it is required to coat the magnet on the carrier 1, after the carrier 1 being transported to a corresponding position, the conveyor belt 900 descends below the top surface 203 by the lifting device, and at least part of the conveyor belt 900 and at least part of the support are both located in the base 2, such that the carrier 1 is located on the top surface 203, which is conducive for the positioning assembly 4 cooperating with the limiting assembly 3 to position and fix the carrier 1.

After the surface of the magnet being coated with the mixture, the magnet enters to the curing device to be performed the light curing treatment. In some embodiments of the present disclosure, the curing device 200 includes a cavity 8, at least part of the light sources 704, 708 are exposed to the cavity 8, and at least part of the conveyor belt 900 is located in the cavity. When the apparatus is in the second working state, at least part of the carrier 1 is located in the cavity. Therefore, the illumination region of the light sources 704 and 708 can be limited in the cavity.

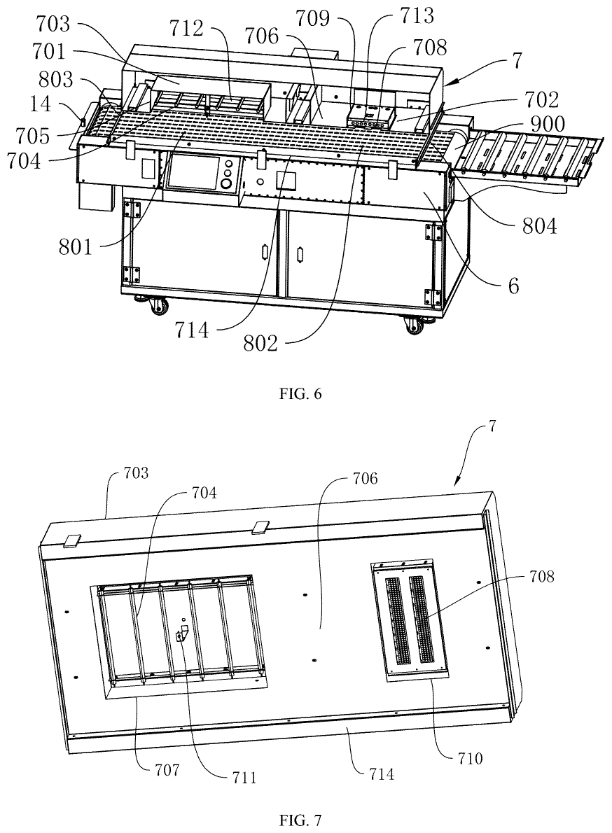

In some embodiments of the present disclosure, referring to FIGS. 6 to 8, the curing device 200 includes an operating platform 6 and the light sources 704, 708 configured to perform the light curing treatment for the composite material on the surface of the magnet. The curing device includes a cavity 8. The operating platform 6 and the light sources 704, 708 are all located outside the cavity 8. Along a height direction H of the curing device, at least part of the operating platform 6 is located on one side of the cavity 8, and the light sources 704, 708 are located on the other side of the cavity 8. The light sources 704, 708 are denoted as a first light source 704 configured to pre-heat the composite material and a second light source 708 configured to light-cure the composite material. At least part of the first light source 704 is exposed in the cavity 8, and at least part of the second light source 708 is exposed in the cavity 8. The composite material on the surface of the magnet contains the diffusion material and the light curing agent. In the present disclosure, the curing device includes a light source configured to perform the light curing treatment on the composite material on the surface of the magnet, the light source generates small heat, which can reduce a risk of the composite material on the surface of the magnet losing efficacy during the curing process.

In some embodiments of the present disclosure, at least part of the conveyor belt 900 penetrates through the operating platform 6. As shown in FIG. 7, when the apparatus is in the second working state, along the height direction of the curing device, at least part of the carrier 1 moves towards the light sources 704, 708 relative to the operating platform 6.

In some embodiments of the present disclosure, the first light source 704 is an infrared light source, and the second light source 708 is an ultraviolet light source. In some embodiments of the present disclosure, the first light source 704 is a laser light source, and the second light source 708 is a laser light source. During a process of preparing the magnet, at least part of the surface of the magnet coated the composite material subsequently passes through the first light source 704 and the second light source 708. By a pre-heating effect of the first light source 704, the light curing agent coated on the surface of the magnet can be leveled and cured by the light curing effect light curing effect of the second light source 708. Therefore, the composite material can more uniformly cover on the magnet to be prepared.

The operating platform 6 is configured to carry the conveyor belt 900 and the box body 7, by a covering effect of the box body 7, reducing an effect of the external environment for the light curing effect. With a transporting effect of the conveyor belt 900, the mixture of the surface of the magnet is subsequently performed the preheating treatment and the curing treatment, thereby greatly improving an efficiency of the production and forming a streamlined operation mode. The apparatus includes light sources 704, 708. The light sources 704, 708 include an infrared light source 704 and an ultraviolet light source 708, which will be described in detail hereinafter.

In some embodiments of the present disclosure, the curing device includes a preheating unit 701 and a curing unit 702. The preheating unit 701 includes a first light source 704, and the curing unit 702 includes the second light source 708. The preheating unit 701 includes a first cavity 801, the curing unit 702 includes a second cavity 802, the first cavity 801 is in communication with the second cavity 802, and the cavity 8 includes the first cavity 801 and the second cavity 802. At least part of the light source 704 is exposed to the first cavity 801, and at least part of the second light source 708 is exposed to the second cavity 802.

An inner part of the box body 7 is separated into two parts by the first cavity 801 and the second cavity 802, in which a part covered by the first light source 704 is a preheating region, a part covered by the second zone 708 is a curing region, the two regions are located in the cavity 8 of the curing device 200, such that the composite material on the surface of the magnet can be immediately performed the light curing treatment after the composite material being preheated, facilitating the efficiency of the production and reducing the effect of the external environment for the light curing treatment. In some embodiments of the present disclosure, along the conveying path of the conveyor belt 900, the preheating unit 701 is located towards the coating device 100 relative to the curing unit 702.

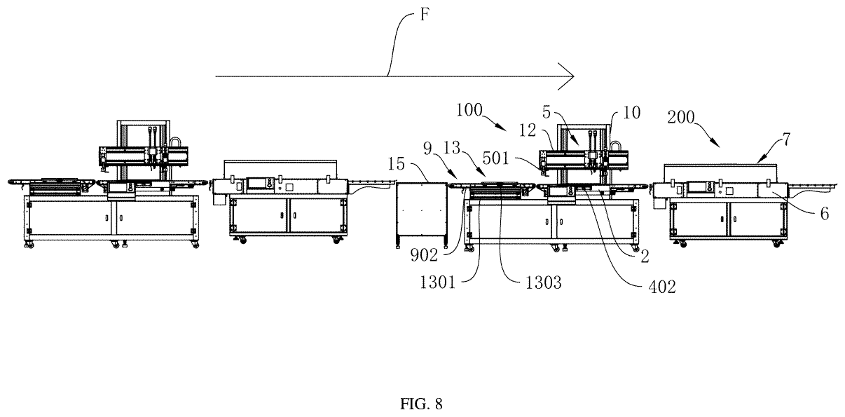

In some embodiments of the present disclosure, the curing device 200 includes a temperature measuring element 711. For example, referring to FIG. 8, the temperature measuring element 711 is configured to detect an environment temperature of the cavity 8, and at least part of the temperature measuring element 711 is located in the cavity 8. In some embodiments of the present disclosure, along the height direction of the curing device 10, the temperature measuring element 711 is located towards the operating platform 6 relative to the light source. Therefore, the temperature detected by the temperature measuring element is more close to a heated temperature of the magnet to be prepared on the carrier 1.

In particular, the temperature measuring element 711 is located in the first cavity 801 relative to the infrared light source. A first cavity 801 where the magnet firstly passes after entering into the cavity 8 is a preheating zone, and a light emitted from the infrared light source can reach the preheating zone. By providing the temperature measuring element 711 in the first cavity for timely monitoring the preheating temperature, thereby reducing a failure of the composite material losing efficacy due to excessive heating, and avoiding a poor preheating and leveling phenominon caused by insufficient temperature. In particular, the temperature measuring element 711 can be a thermocouple or other elements that can monitor temperature changes and emit signal.

In some embodiments of the present disclosure, the curing device includes a box body 7, the box body 7 is connected to the operating platform 6, and the box body 7 is located on periphery of the cavity 8. The light sources 704, 708 are fixedly connected to or limitedly connected to the box body 7. The box body 7 includes accommodating cavities 712, 713, the accommodating cavities 712, 713 are both in communication with the cavity 8, and at least part of the light sources 704 and 708 are located in the accommodating cavities 712, 713.

In particular, the accommodating cavities 712, 713 includes a first accommodating cavity 712 and a second accommodating cavity 713, along the length direction L or the width direction W of the curing device, and at least part of the box body 7 is located between the first accommodating cavity 712 and the second accommodating cavity 713. The first accommodating cavity 712 and the second accommodating cavity 713 are both in communication with the cavity 8, at least part of the first light source 704 is located in the first accommodating cavity 712, and at least part of the second light source 708 is located in the second accommodating cavity 713.

The cavity 8 is formed by a gap between an inner space of the box body 7 and the operating platform 6, and the box body 7 is fixedly connected to the operating platform 6, so as to fix positions of the first light source 704 and the second light source 708. Illumination regions of the first light source 704 and the second light source 708 are located in the cavity 8, and the illumination region of the first light source 704 can overlap or not overlap with that of the second light source 708.

The box body 7 includes an outer housing 703. The preheating unit 701 includes a first inner housing 705. The outer housing 703 includes a baseplate 706. The baseplate 706 is provided with a first groove 707. The first inner housing 705 is located in the outer housing 703. The first inner housing 705 is connected to the baseplate 706. The first inner housing 705 is located on periphery of the first groove 707. At least part of the first groove 704 is located in the first inner housing 705. The curing unit 702 includes a second inner housing 709. The baseplate 706 is provided with a second groove 710. The second inner housing 709 is located in the outer housing 703. The second inner housing 709 is connected to the baseplate 706. The second inner housing 709 is located around the second groove 710. At least part of the first inner housing 705 and at least part of the second inner housing 709 are both located in the outer housing 703. At least part of the first accommodating cavity 712 is located in the first inner housing 705, and at least part of the second accommodating cavity 713 is located in the second inner housing 709.

By providing the first inner housing 705, on one hand, the outer housing 703 has a protective effect, on the other hand, light transmittance of the first inner housing 705 is lower. The affections of the external environment can be avoided by the outer housing 703, the first inner housing 705 can provide a point position for the first light source 704 to connect, at least part of the first accommodating cavity 712 is located in the first inner housing 705, so that it can further avoid an effect from the external environment on the first inner housing 705 and play a role of protection. The first groove 707 is conducive for the light source emitted from the first light source 704 illuminating to the first inner cavity 801, i.e., the preheating region and playing a pre-heating role.

The second inner housing 709 plays a same role of the first inner housing 705. On one hand, the outer housing 703 plays a protection role, at least part of the second accommodating cavity 713 is located in the second inner housing 709, and on the other hand, the light transmittance of the second inner housing 709 is lower. Effect of the external environment can be avoided by the outer housing 703, the second inner housing 705 can provide a position for connecting the second light source 708, so as to further prevent the effect of the external environment and play a role of protection, then facilitating a better curing effect.

The box body 7 includes a bottom surface 715. The bottom surface 715 is located on periphery of the cavity 8. At least part of the bottom surface 715 is exposed to the inner cavity 8. Along the height direction H of the curing device 200, the bottom surface 715 is located on a side of the box body 7 towards the cavity 8. A distance is formed between the bottom surface 715 and the operating platform 6. The box body 7 is provided with a protrusion 714. The protrusion 714 protrudes towards the operating platform 6 from the bottom surface 715. The protrusion 714 is located on periphery of the cavity 8 and connected to the operating platform 6. The protrusion 714 extends along the length direction of the curing device. The protrusion 714 is sealed with and connected to the operating platform 6. The bottom surface 715 extends along the length direction of the curing device. The cavity 8 is provided with a first opening 803 and a second opening 804. The first opening 803 and the second opening 804 are located on two sides of the box body 7, respectively.

A distance between the bottom surface 715 and the operating platform 6 is configured to form the cavity 8, facilitating flowing and transporting of the magnet to be prepared. The first opening 803 is an inlet of the cavity 8 and the second opening 804 is an outlet of the cavity 8. In order to facilitate realizing automated production, an optoelectronic sensor 14 can be mounted on positions of the operating platform 6 or the outer housing 703 corresponding to the first opening 803 and the second opening 804. Thereby, when the magnet to be prepared passes the optoelectronic sensor 14, a signal can be emitted to control the curing device 200 to start working to preheat and perform the light curing treatment for the mixture of the surface of the magnet to be prepared. By the protrusion 714, on one hand, it is used to increase strength of overall box body 7, and on the other hand, it is conducive to improving a sealing performance of overall box body 7, thereby preventing an external light or environment and other factories from affecting the preheating and light curing treatments.

Along the height direction of the curing device, the operating platform 6 and the first light source 704 are located on two sides of the cavity 8, respectively. Alternatively, at least part of the operating platform 6 is located on a side of the cavity 8, and the first light source 704 is located on the periphery of the cavity 8. Along the height direction of the curing device 200, the operating platform 6 and the second light source 708 are located on two sides of the cavity 8, respectively. Alternatively, at least part of the operating platform 6 is located on a side of the cavity 8, and the second light source 708 is located on the periphery of the cavity 8. In one embodiment, referring to FIGS. 7 to 8, along the height direction of the apparatus, the first light source 704 and the second light source 708 are located on a same side of the cavity 8, and the operating platform 6 is located on one side of the cavity 8 and the first light source 704 and the second light source 708 are located on the other side of the cavity 8.

When the magnet is processed, to improve the production efficiency, the coating device 100 is close to the curing device 200, and the preheating unit 701 is more close to the coating device 100, such that a coated magnet can enter to a preheating segment to be preheated quickly, and if a time interval is too long, an effect of the pre-heating is bad, and a relatively long conveying path may reduce an efficiency of the production.

Furthermore, the apparatus includes at least two coating and curing units and a flipping table 15 configured to flip the magnet to be coated. The coating device 100 and the curing device 200 are defined as the coating and curing unit. Along a conveying path F of the conveyor belt, the flipping table 15 is located between the two coating and curing units. In particular. The at least two coating and curing units includes a first coating and curing unit 1000, a second coating and curing unit 2000 and the flipping table 15 configured to flip the magnet to be coated. The first coating and curing unit 1000 includes a first coating device 1001 and a first curing device 2001, and the second coating and curing unit 2000 includes a second coating device 1002 and a second curing device 2002. Along the conveying path F of the conveyor belt, the first curing device 2001 is located between the first coating device 1001 and the flipping table 15, the second coating device 1002 is located between the flipping table 15 and the second curing device 2002, and the flipping table 15 is located between the first curing device 2001 and the second curing device 1002.

On a working process for the coating and curing unit, since the magnet is disposed on the carrier 1, the coating and the light curing treatments are merely processed on one surface of the magnet. By the two coating and curing units and the flipping table 15 provided therebetween, when one surface of the magnet has been coated and light-cured from a previous coating and curing unit, the magnet can be flipped over manually or by machine and immediately enter to next coating and curing unit, and the other side of the magnet can be coated and performed the light curing treatment, thereby significantly improving the production efficiency.

The present disclosure further provides a magnetic material. The magnetic material includes a magnet and a coating layer. The coating layer is disposed on at least part of the magnet. The coating layer includes a diffusion material and a light curing material. The light curing material is formed by a light curing agent through the light curing treatment.

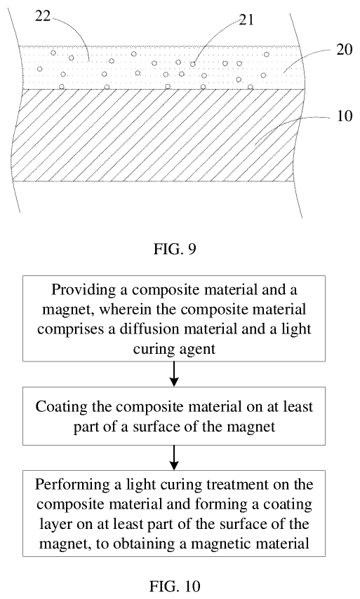

Referring to FIG. 9, the magnetic material includes the magnet 10 and the coating layer 20. The coating layer 20 is disposed in at least part of the surface of the magnet 10. The light curing material 22 is combined with the diffusion material 21. The light curing material 22 is cured by the light curing agent under a lighting condition.

In the magnetic material of the present disclosure, the diffusion material 21 is combined with the magnet 10 by a light curing material 22. The light curing material 22 is formed by the light curing agent at a room temperature under the lighting condition, reducing a temperature of combination of the diffusion material 21 and the magnet 10.

Furthermore, referring to FIG. 10, the present disclosure further provides a method for preparing a magnetic material. The method includes following step:
providing a composite material and a magnet, wherein the composite material includes a diffusion material and a light curing agent;
coating the composite material on at least part of a surface of the magnet; and
performing a light curing treatment for the composite material and forming a coating layer on at least part of the surface of the magnet, to obtain the magnetic material.

In the method for preparing the magnetic material of the present disclosure, the light curing agent and the diffusion material are first mixed in a certain ratio, and the light curing treatment is then performed on the diffusion material coated on the surface of the magnet, Such that curing time becomes a few seconds, thereby greatly shortening the curing time and simplifying a diffusing process. A percentage of the magnetic material of which the magnetic property reaching the standard rate is improved.

In the present disclosure, the diffusion material and the light curing agent are mixed to prepare the composite material, the composite material can be in combination with the magnet after performing the light curing treatment, i.e., the diffusion material is combined with the magnet, thereby reducing a temperature of combination of the diffusion material and the magnet.

In order to enable the diffusion material to be tight combined on the surface of the magnet, the diffusion material will not be detached from the surface of the magnet before or during a grain boundary diffusion treatment. In related technology, the composite material is formed by combining the heat curable agent and the diffusion material, and the heat curing treatment is performed on the composite material. However, the heat curing treatment is easy to affect the magnet and the diffusion material. For example, since the heat curing treatment is easy to cause a surface oxidation of the magnet due to high temperature and long processing time and cause diffusion material oxidation and combustion to lose efficacy, thereby affecting the subsequent grain boundary diffusion treatment. Therefore, it is required to choose the magnet and the diffusion material in application, for example, it chooses a magnet and a diffusion material that are not easily oxidized during the hot curing process. Therefore, applications of the grain boundary diffusion treatment are limited. Alternatively, the heat curing treatment requires to be performed under vacuum or inert atmosphere. A cost and difficulty of combining the diffusion material and magnet increase before the grain boundary diffusion treatment, and which is not conducive to realizing an automated production on assembly lines. For example, since the heat curing treatment is performed in the vacuum or inert atmosphere and at a high temperature, it is hard to transport the magnet to a vacuum furnace or an atmosphere furnace by the conveyor belt and transport a magnet with the diffusion material from the vacuum furnace or the atmosphere furnace after being cured.

In the present disclosure, the light curing agent and the diffusion material are mixed to prepare the composite material, and the composite material containing the diffusion material is combined with the magnet through the light curing treatment, which is prepared for the subsequent grain boundary diffusion treatment. Since a temperature rise of the composite material and the magnetic material during the light curing treatment is lower than that of the heat curing process in the related art, a negative affection in a combination process of the magnet and the diffusion material is reduced, for example, a risk of the oxidization during the curing process of combining the magnetic and the diffusion material is reduced if a curing time is decreased. In addition, since the temperature rise of the magnet and the composite material containing the diffusion material caused by the light curing process is relatively low, and the light curing time is less (less than or equal to 5 minute), which has a relatively small affection for the magnet and the diffusion material. Therefore, the light curing treatment can be performed at a normal temperature and in an open environment. An energy consumption of the light curing treatment is lower than that of the heat curing treatment. The light curing agent is mixed with the diffusion material to prepare the composite material, and the diffusion material is combined with the magnet by performing the light curing treatment on the composite material. It can reduce a risk of the magnet and the diffusion material losing efficacy during a combination process, facilitate the subsequent grain boundary diffusion treatment. It is conducive to reducing the energy consumption and the cost and is conducive for the required automated production on assembly lines. For example, the magnet is required to transfer to a light curing device by the conveyor belt and the magnet containing the diffusion material is required to transfer from the light curing device after being cured. In the method, the diffusion material is one or more of heavy rare earth hydrides, heavy rare earth fluorides, heavy rare earth oxides, heavy rare earths and alloys thereof.

In some examples, a mass ratio of the diffusion material to the light curing agent is in a range of 3:1 to 8:1. If a mass ratio of the diffusion material to the light curing agent is too high, it will result in the light curing agent can not be combined with the diffusion material and the magnet, respectively. If the mass ratio of the diffusion material to the light curing agent is too small and the amount of the diffusion material is insufficient, it will cause the subsequent grain boundary diffusion treatment to be difficult to achieve desired magnetic property of the magnet. In the present disclosure, the mass ratio of the diffusion material and the light curing agent is limited in a range of 3:1 to 8:1, enabling the diffusion material to combine with the magnet and ensuring a sufficient amount of the diffusion material to improve the magnetic property of the magnet significantly after performing the grain boundary diffusion treatment.

In some examples, after the light curing treatment being performed on the composite material, a weight increase percentage of two surfaces of the magnet is in a range of 0.1% to 2.0%. In some examples, after the light curing treatment being performed on the composite material, the weight increase percentage of two surfaces of the magnet is 1%.

In the related technology, the composite material includes a heat curable agent. In order to enable the composite material to be fixed on the surface of the magnet, it is required to perform the heat curing treatment on the magnet with the composite material. The heat curing treatment is prone to effect the magnet and the diffusion material, for example, since the heat curing treatment is easy to cause the surface oxidation of the magnet due to high temperature and long processing time and cause diffusion material oxidation and combustion to lose efficacy, thereby affecting subsequent grain boundary diffusion treatment. Therefore, it is required to choose the magnet and the diffusion material in application, for example, it chooses a magnet and a diffusion material that are not easily oxidized during the hot curing process. Therefore, an application of the grain boundary diffusion treatment is limited. In the present disclosure, since the temperature rise of the magnet and the composite material with the diffusion material caused by the light curing process is relatively low, and the light curing time is less (less than or equal to 5 minutes), which has a relatively low affection for the magnet and the diffusion material, such that the magnet and the diffusion material capable of applying the grain boundary diffusion treatment to improve the magnetic properties have more selections.

Furthermore, the light curing agent includes at least one of an infrared light curing agent, a visible light curing agent, and an ultraviolet light curing agent. The visible light curing agent includes prepolymer containing olefinic unsaturated group of 0 to 20 wt %, monomer containing olefinic unsaturated groups of 20 wt % to 80 wt %, a photoinitiator of 1 wt % to 10 wt %, a co-initiator of 0.5 wt % to 30 wt %, an additive of 0 to 10 wt %, a filler or a pigment of 0 to 40 wt %, and a solvent of 0 to 30 wt %. The ultraviolet light curing agent includes epoxy acrylate of 1 wt % to 35 wt %, polyurethane acrylate of 1 wt % to 35 wt %, multi-functional acrylate monomer of 20 wt % to 50 wt %, an additive of 1 wt % to 15 wt %, and a photoinitiator of 1 wt % to 10 wt %.

In some embodiments, the step of providing the composite material further includes following steps: processing the diffusion material in a powder form, and mixing the diffusion material in a powder form with the light curing agent.

In some embodiments, the step of coating the composite material on at least part of the surface of the magnet further includes following steps: coating the composite material on at least part the surface of the magnet by at least one method of printing, spraying, roller coating, and immersion coating.

In some embodiments, the step of performing a light curing treatment on the composite material further includes following steps: curing the composite material by at least one of the near infrared light, the ultraviolet light, and the visible light. The curing time is in a range of 0.5 s to 300 s. In some embodiments, the step of performing the light curing treatment on the composite material includes following steps: curing the composite material by at least one of the near infrared light, the ultraviolet light, and the visible light. The curing time is in a range of 0.5 s to 60 s.

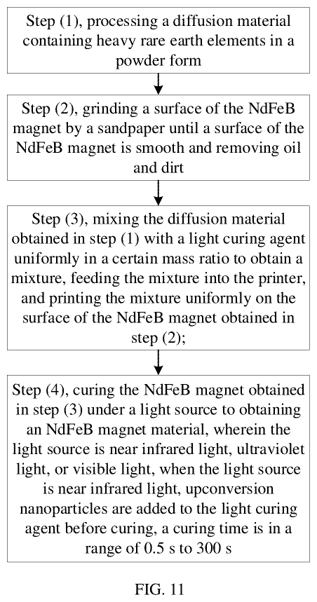

Referring to FIG. 11, the present disclosure provides a method for preparing neodymium-iron-boron (NdFeB) magnet material, the method includes following steps:
step (1), processing the diffusion material containing heavy rare earth elements into a powder form;
step (2), grinding a surface of the NdFeB magnet until the surface of the NdFeB magnet is smooth, and removing oil and dirt;
step (3), mixing the diffusion material obtained in step (1) with the light curing agent uniformly in a certain mass ratio to obtain a mixture, feeding the mixture into the printer, printing the mixture uniformly on a surface of the NdFeB magnet obtained in step (2); and
step (4), curing the NdFeB magnet obtained in step (3) under a light source, wherein the light source is the near infrared light, the ultraviolet light, or the visible light, when the light source is the near infrared light, upconversion nanoparticles (UCNPs) is added to the light curing agent, the curing time is in a range of 0.5 s to 300 s.

In step (4), the curing times can be 1 s, 2 s, 5 s, 10 s, 20 s, 60 s, 150 s and so on.

Furthermore, the method further includes step (5), under a protective atmosphere of Ar, first maintaining the NdFeB magnet obtained in step (4) at 100° C. to 500° C. for 5 min to 600 min, then performing a heat treatment at 750° C. to 1000° C. for 4 h to 20 h, and finally annealing at 400° C. to 600° C. for 0 h to 15 h.

The step of maintaining the NdFeB magnet in step (4) at 100° C. to 500° C. is used to remove the light curing agent on the surface. The step of performing the heat treatment at 750° C. to 1000° C. is used for sintering diffusion, and the step of annealing at 400° C. to 600° C. is used to remove many defects formed during high-temperature diffusion, such as vacancies, interstitial atoms, dislocations, stacking faults, impurity induced defects, and so on. After annealing, lattice defects can be repaired and the number of recombination centers is reduced.

The present disclosure provides a method for preparing the NdFeB material. The light curing agent and the diffusion material are mixed by a certain ratio to obtain a mixture, the light curing treatment is performed on the mixture coated on the surface of the NdFeB magnet, such that curing time becomes a few seconds, thereby greatly shortening the curing time of the curing process, greatly simplifying a diffusing process. A percentage of the magnetic material of which the magnetic property reaching the standard rate is improved.

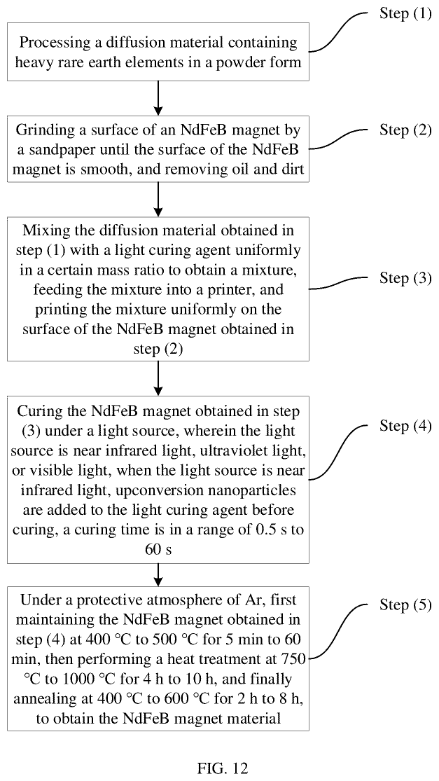

Referring to FIG. 12, the present disclosure further provides a method for preparing neodymium-iron-boron (NdFeB) magnet material. The method includes following steps:
step (1), processing a diffusion material containing heavy rare earth elements in a powder form;
step (2), grinding a surface of an NdFeB magnet by a sandpaper until the surface of the NdFeB magnet is smooth, and removing oil and dirt;
step (3), mixing the diffusion material obtained in step (1) with a light curing agent uniformly in a certain mass ratio to obtain a mixture, feeding the mixture into a printer, and printing the mixture uniformly on the surface of the NdFeB magnet obtained in step (2);
step (4), curing the NdFeB magnet obtained in step (3) under a light source, wherein the light source is near infrared light, ultraviolet light, or visible light, when the light source is near infrared light, upconversion nanoparticles are added to the light curing agent before curing, a curing time is in a range of 0.5 s to 300 s; and
step (5), under a protective atmosphere of Ar, first maintaining the NdFeB magnet obtained in step (4) at 400°° C. to 500° C. for 5 min to 60 min, then performing a heat treatment at 750° C. to 1000° C. for 4 h to 10 h, and finally annealing at 400° C. to 600° C. for 2 h to 8 h, to obtain the NdFeB magnet material.

In step (4), when the light source is near-infrared light, up-conversion nanoparticles are added to the light curing agent. Due to adding of upconversion nanoparticles (UCNPs) to the light curing agent, the light curing agent can excite photons with shorter wavelengths under the near-infrared light irradiation, causing the photoinitiator to generate free radicals, achieving crosslinking reaction of the light curing agent, and completing curing of colloid. A concentration of the UCNPs can be adjusted to optimize curing speed of the colloids under the near-infrared light irradiation.

When the light source is the visible light or the ultraviolet light, the concentration of the visible light or the ultraviolet light can be adjusted to optimize the curing speed of the colloid under the visible light or the ultraviolet light irradiation.

In step (5), the step of maintaining the NdFeB magnet in step (4) at 400° C. to 500° C. is used to remove the light curing agent on the surface. The step of performing the heat treatment at 750°° C. to 1000° C. is used for sintering diffusion, and the step of annealing at 400° C. to 600° C. is used to remove many defects formed during high-temperature diffusion, such as vacancies, interstitial atoms, dislocations, stacking faults, impurity induced defects, and so on. After annealing, lattice defects can be repaired and the number of recombination centers is reduced.

In some embodiments, in step (1), the diffusion material is one or more of heavy rare earth hydrides (DyH₃, TbH₃, etc.), heavy rare earth fluorides (DyF₃, TbF₃, etc.), heavy rare earth oxides (Dy₂O₃, Tb₂O₃, etc.), heavy rare earths and alloys thereof (Dy, Tb, PrCu, DyCu, TbCu, etc.). Of course, the diffusion material is not limited herein.

In some examples, in step (3), a mass ratio of the diffusion material to the light curing agent is in a range of 3:1 to 8:1.

The light curing agent has many selections, as long as it corresponds to the light source. The source of UV curable agent can be self-made or purchased. For example, the visible light curing agent includes prepolymer containing olefinic unsaturated group of 0 to 20 wt %, monomer containing olefinic unsaturated groups of 20 wt % to 80 wt %, photoinitiator of 1 wt % to 10 wt %, co-initiator of 0.5 wt % to 30 wt %, additive of 0 to 10 wt %, filler or pigment of 0 to 40 wt %, and solvent of 0 to 30 wt %.

The ultraviolet light curing agent includes epoxy acrylate of 1 wt % to 35 wt %, polyurethane acrylate of 1 wt % to 35 wt %, multi-functional acrylate monomer of 20 wt % to 50 wt %, an additive of 1 wt % to 15 wt %, and a photoinitiator of 1 wt % to 10 wt %.

In some embodiments, in step (3), a weight increase percentage of two surfaces of the magnet is in a range of 0.1% to 2.0%. In some embodiments, in step (3), the weight increase percentage of two surfaces of the magnet is 1%.

In some embodiments, in step (4), an adding concentration of the upconversion nanoparticles is in a range of 0.5% to 5%.

The method for preparing the NdFeB material includes following beneficial effects:
1. In the present disclosure, the lightcuring method is applied in NdFeB grain boundary diffusion technology, thereby realizing a fast curing of the diffusion material, shortening a curing time, significantly simplifying the diffusion process, and reducing a time and a labor cost. A percentage of the high-performance sintered neodymium iron boron alloy of which the magnetic property reaching the standard rate is improved;
2. In the present disclosure, by different light curing agents, it can realize full wavelength light curing printing grain boundary diffusion technology in the near-infrared light, the visible light, and the ultraviolet light, and has strong universality, which is beneficial for practical production;
3. In the present disclosure, the diffusion material is uniformly coated on the surface of the magnet by the machine printing, which is conducive for the diffusion material of heavy rare earth elements in subsequent heat treatment, to obtain a magnet with higher coercivity.

In conclusion, the present disclosure provides a method for preparing the NdFeB material, the light curing agent and the diffusion material are first mixed in a certain ratio, and the light curing treatment is then performed on the diffusion material coated on the surface of the magnet, Such that curing time becomes a few seconds, thereby greatly shortening the curing time and simplifying a diffusing process. A percentage of the magnetic material of which the magnetic property reaching the standard rate is improved.

The present disclosure further provides a magnetic material preparation apparatus 3000. The apparatus includes a coating device 100, a curing device 200 and a conveyor device 9. In particular, the coating device 100 includes a coating assembly 5. The coating assembly 5 is configured to coat the composite material containing the diffusion material and the light curing agent on the surface of an intermediate magnetic material to be prepared. The curing device 200 includes light sources 704, 708, the light sources is configured to perform a light curing treatment on the composite material. The conveyor device 9 is configured to support the intermediate magnetic material to be prepared. The apparatus 3000 can be in the first working state and the second working state, when the apparatus 3000 is in the first working state, the coating assembly 5 coats the composite material containing the diffusion material on the surface of the intermediate magnetic material to be prepared. When the apparatus 3000 is in the second working state, the light sources 704, 708 perform the light curing treatment for the composite material. Components of the apparatus are substantially the same as those of the apparatus shown in FIGS. 1 to 8, which is not limited herein.

Furthermore, the present disclosure further provides a method for preparing the magnetic material. The method includes following steps.
providing a composite material and a magnet, wherein the composite material includes a diffusion material and a light curing agent;
coating the composite material on at least part of surface of the magnet;
performing a light curing treatment on the composite material and forming a coating layer on at least part of the surface of the magnet; and
performing a heat treatment on the magnet with the coating layer under a protection of Ar.

In the method for preparing the magnetic material of the present disclosure, the light curing agent and the diffusion material are first mixed in a certain ratio, and the light curing treatment is then performed on the diffusion material coated on the surface of the magnet, Such that curing time becomes a few seconds, thereby greatly shortening the curing time and simplifying a diffusing process. A percentage of the magnetic material of which the magnetic property reaching the standard rate is improved.

In the method, the diffusion material is one or more of heavy rare earth hydrides, heavy rare earth fluorides, heavy rare earth oxides, heavy rare earths and alloys thereof. Mass ratio of the diffusion material to the light curing agent is in a range of 3:1 to 8:1. A weight increase percentage of two surfaces of the magnet is in a range of 0.1% to 2.0%. In some embodiments, a weight increase percentage of two surfaces of the magnet is 1%.

Furthermore, the light curing agent includes at least one of an infrared light curing agent, a visible light curing agent, and an ultraviolet light curing agent. The visible light curing agent includes prepolymer containing olefinic unsaturated group of 0 to 20 wt %, monomer containing olefinic unsaturated groups of 20 wt % to 80 wt %, photoinitiator of 1 wt % to 10 wt %, co-initiator of 0.5 wt % to 30 wt %, additive of 0 to 10 wt %, filler or pigment of 0 to 40 wt %, and solvent of 0 to 30 wt %. The ultraviolet light curing agent includes epoxy acrylate of 1 wt % to 35 wt %, polyurethane acrylate of 1 wt % to 35 wt %, multi-functional acrylate monomer of 20 wt % to 50 wt %, additive of 1 wt % to 15 wt %, and photoinitiator of 1 wt % to 10 wt %.

Furthermore, the heat treating includes following steps: first maintaining the magnet with the coating layer at 100° C. to 500°° C. for 5 min to 600 min, then performing a heat treatment at 750°° C. to 1000°° C. for 4 h to 20 h, and finally annealing at 400° C. to 600° C. for 0 h to 15 h.

In some examples, the heat treatment process includes following steps: first maintaining the magnet with the coating layer at 400° C. to 500° C. for 5 min to 60 min, then performing a heat treatment at 750° C. to 1000° C. for 4 h to 10 h, and finally annealing at 400° C. to 600° C. for 2 h to 8 h.

After the heat treatment, the diffusion material can diffuse on the surface and inner of the magnet and the light curing material is ablated and removed. Therefore, the processed magnetic material has excellent magnetic properties.

The following detailed examples make a further detailed description of the method for preparing the magnetic material or the NdFeB magnet material.

### EXAMPLE 1

Step (1), Dy₂O₃ diffusion material was ground and sieved into powder by hand.
Step (2), a surface treatment of an NdFeB magnet was processed as following. A surface

of the NdFeB magnet with a size of 10 mm*10 mm*5 mm was ground by a sandpaper until the surface of the NdFeB magnet was smooth. Then oil and dirt were further removed to remove an oxide film on the surface of the NdFeB magnet. After above treatments, the NdFeB magnet was ready for use.
Step (3), the powder diffusion material obtained in step (1) was mixed with an ultraviolet light curing agent uniformly in a mass ratio of 3:1 to obtain a mixture. The mixture was feeded into a print to perform a screen print. The mixture of the diffusion material and the ultraviolet light curing agent was uniformly printed on the surface of the NdFeB magnet obtained in step (2). A weight increase percentage of two surfaces of the magnet was 1%.
Step (4), the NdFeB magnet obtained in step (3) was cured under an ultraviolet light source of 250 nm for 0.5 s. After curing, the mixture was uniformly fixed on the surface of the NdFeB magnet.
Step (5), the NdFeB magnet obtained in step (4) was performed a heat treatment under a protection of Ar. Organic matters were removed by keeping temperature at 450° C. for 30 minutes until pressure was stabilized. A heat treating was further performed at 900° C. for 6 hours, and then an annealing treatment was performed at 500° C. for 5 hours to obtain a high-coercivity NdFeB magnet material.

Magnetic properties of high-performance composite magnet material prepared in this example were measured as following: a coercivity was 20.8 kOe, a coercivity increment was 5.2 kOe, a magnetic energy product was 38.4 MGOe, and a density was 7.85 g/cm³.

### EXAMPLE 2

Step (1), Tb diffusion material was ground and sieved into powder by hand.
Step (2), a surface treatment of an NdFeB magnet was processed as following. A surface of the NdFeB magnet with a size of 10 mm*10 mm*5 mm was ground by a sandpaper until the surface of the NdFeB magnet was smooth. Then oil and dirt were further removed to remove an oxide film on the surface of the NdFeB magnet. After the above treatments, the NdFeB magnet was ready for use.
Step (3), the powder diffusion material obtained in step (1) was mixed with a visible light curing agent uniformly in a mass ratio of 5:1 to obtain a mixture. The mixture was feeded into a print to perform a screen print. The mixture of the diffusion material and the ultraviolet light curing agent was uniformly printed on the surface of the NdFeB magnet obtained in step (2). A weight increase percentage of two surfaces of the magnet was 1%.
Step (4), the NdFeB magnet obtained in step (3) was cured under a visible light source of 500 nm for 20 s. After curing, the mixture was uniformly fixed on the surface of the NdFeB magnet.
Step (5), the NdFeB magnet obtained in step (4) was performed a heat treatment under a protection of Ar. Organic matters were removed by keeping temperature at 400° C. for 5 minutes until pressure was stabilized. A heat treating was further performed at 750° C. for 4 hours, and then an annealing treatment was performed at 400° C. for 2 hours to obtain a high-coercivity NdFeB magnet material.

Magnetic properties of high-performance composite magnet material prepared in this example were measured as following: a coercivity was 26.1 kOe, a coercivity increment was 9.0 kOe, a magnetic energy product was 39.6 MGOe, and a density was 7.91 g/cm³.

### EXAMPLE 3

Step (1), DyF₃ diffusion material was ground and sieved into powder by hand.
Step (2), surface treatment of an NdFeB magnet was processed as following. A surface of the NdFeB magnet with a size of 10 mm*10 mm*5 mm was ground by a sandpaper until the surface of the NdFeB magnet was smooth. Then oil and dirt were further removed to remove an oxide film on the surface of the NdFeB magnet. After above treatments, the NdFeB magnet was ready for use.
Step (3), the powder diffusion material obtained in step (1) was mixed with an infrared light curing agent (in the infrared light curing agent, upconversion nanoparticles were added with a mass ratio of upconversion nanoparticles to the infrared light curing agent is 1:100) uniformly in a mass ratio of 8:1 to obtain a mixture. The mixture was feeded into the print to perform the screen print, the mixture of the diffusion material and the infrared light curing agent was uniformly printed on the surface of the NdFeB magnet obtained in step (2). A weight increase percentage of two surfaces of the magnet was 1%.
Step (4), the NdFeB magnet obtained in step (3) was cured under a near-infrared light source of 900 nm for 20 s. After curing, the mixture was uniformly fixed on the NdFeB magnet.
Step (5), the NdFeB magnet obtained in step (4) was performed a heat treatment under a protection of Ar. Organic matters were removed by keeping temperature at 500° C. for 60 minutes until pressure was stabilized. A heat treating was performed at 950° C. for 10 hours, and then an annealing treatment was performed at 600° C. for 8 hours to obtain a high-coercivity NdFeB magnet material.

Magnetic properties of high-performance composite magnet material prepared in this example were measured as following: a coercivity was 21.2 kOe, a coercivity increment was 5.8 kOe, a magnetic energy product was 37.5 MGOe, and a density was 7.83 g/cm³.

### EXAMPLE 4

Step (1), Tb diffusion material was ground and sieved into powder by hand.
Step (2), a surface treatment of a NdFeB magnet was processed as following. A surface of the NdFeB magnet with a size of 10 mm*10 mm*5 mm was ground by a sandpaper until the surface of the NdFeB magnet was smooth. Then oil and dirt were further removed to remove an oxide film on the surface of the NdFeB magnet. After the above treatments, the NdFeB magnet was ready for use.
Step (3), the powder diffusion material obtained in step (1) was mixed with a visible light curing agent uniformly in a mass ratio of 5:1 to obtain a mixture. The mixture was feeded into a print to perform a screen print. The mixture of the diffusion material and the visible light curing agent was uniformly printed on the surface of the NdFeB magnet obtained in step (2). A weight increase percentage of two surfaces of the magnet was 0.4%.
Step (4), the NdFeB magnet obtained in step (3) was cured under a visible light source of 500 nm for 180 s. After curing, the mixture was uniformly fixed on the surface of the NdFeB magnet.
Step (5), the NdFeB magnet obtained in step (4) was performed a heat treatment under a protection of Ar. Organic matters were removed by keeping temperature at 400° C. for 5 minutes until pressure was stabilized. A heat treating was performed at 750° C. for 4 hours, and then annealing treatment was performed at 400°° C. for 2 hours to obtain a high-coercivity NdFeB magnet material.

Magnetic properties of high-performance composite magnet material prepared in this example were measured as following: a coercivity was 25.1 kOe, a coercivity increment was 8.0 kOe, a magnetic energy product was 41.6 MGOe, and a density was 7.84 g/cm³.

### EXAMPLE 5

Step (1), DyF₃ diffusion material was ground and sieved into powder by hand.
Step (2), a surface treatment of an NdFeB magnet was processed as following. A surface of the NdFeB magnet with a size of 10 mm*10 mm*5 mm was ground by a sandpaper until the surface of the NdFeB magnet was smooth. Then oil and dirt were further removed to remove an oxide film on the surface of the NdFeB magnet. After above treatments, the NdFeB magnet was ready for use.
Step (3), the powder diffusion material obtained in step (1) was mixed with an infrared light curing agent (in the infrared light curing agent, upconversion nanoparticles were added with a mass ratio of upconversion nanoparticles to the infrared light curing agent is 1:100) uniformly in a mass ratio of 8:1 to obtain a mixture. The mixture was feeded into the print to perform the screen print, the mixture of the diffusion material and the light curing agent was uniformly printed on the surface of the NdFeB magnet obtained in step (2). A weight increase percentage of two surfaces of the magnet was 1.8%.
Step (4), the NdFeB magnet obtained in step (3) was cured under a near-infrared light source of 900 nm, for 250 s. After curing, the mixture was uniformly fixed on the surface of the NdFeB magnet.
Step (5), the NdFeB magnet obtained in step (4) was performed a heat treatment under a protection of Ar. Organic matters were removed by keeping temperature at 500° C. for 60 minutes until pressure was stabilized. A heat treating was further performed at 950° C. for 10 hours, and then an annealing treatment was performed at 600° C. for 8 hours to obtain a high-coercivity NdFeB magnet material.

Magnetic properties of high-performance composite magnet material prepared in this example were measured as following: a coercivity was 22.2 kOe, a coercivity increment was 6.8 kOe, a magnetic energy product was 37.3 MGOe, and a density was 7.84 g/cm³.

The various technical features of the above embodiments can be combined in any way. In order to make the description concise, not all possible combinations of the various technical features in the above embodiments have been described. However, as long as there is no contradiction in the combination of these technical features, they should be considered within the scope of this specification.

The above examples only express several examples of the present disclosure, and their descriptions are more specific and detailed, but should not be understood as limiting the scope of the present disclosure. It should be pointed out that for skill in the art, several modifications and improvements can be made without departing from the concept of this disclosure, which are within the scope of protection of this disclosure. Therefore, the scope of protection of the present patent should be based on the attached claims.

What is claimed is:

1. An apparatus for preparing a magnetic material, comprising:
a coating device, wherein the coating device comprises a coating assembly, the coating assembly is configured to coat a composite material on at least part of a surface of a magnet, and the coating assembly has a coating region;
a curing device, wherein the curing device comprises a light source, the light source is configured to perform a light curing treatment on the composite material, the light source has an illumination region; and
a carrier, wherein the carrier is configured to carry the magnet,
wherein the apparatus has a first working state and a second working state, when the apparatus is in the first working state, at least part of the carrier is located in the coating region of the coating assembly; and when the apparatus is in the second working state, at least part of the carrier is located in the illumination region of the light source.

2. The apparatus of claim 1, further comprising a conveyor device, wherein the conveyor device comprises a conveyor belt and the carrier, the conveyor belt is connected to the carrier;
when the apparatus is in the first working state, along a height direction of the apparatus, at least part of the carrier moves towards the coating assembly relative to the conveyor belt; when the apparatus is in the second working state, along the height direction of the apparatus, at least part of the carrier moves towards the light source relative to the conveyor belt; and
at least part of the conveyor belt is located in the coating device, at least part of the conveyor belt is located in the curing device.

3. The apparatus of claim 2, wherein the light source comprises a first light source and a second light source, the first light source is an infrared light source, the second light source is an ultraviolet light source; and
along a conveying path of the conveyor belt, the first light source is located towards the coating assembly relative to the second light source.

4. The apparatus of claim 1, wherein the curing device comprises an operating platform and a box body, the curing device has a cavity, the operating platform is connected to the box body, the operating platform and the box body are both located on a periphery of the cavity, the light source is fixedly connected to or limitedly connected to the box body, and at least part of the light source is exposed to the cavity.

5. The apparatus of claim 1, wherein the coating device comprises a base, the base has a top surface, the base is provided with a hollow portion, the hollow portion is provided with a through hole, the through hole is provided with an opening, a plane perpendicular to a height direction of the apparatus is defined as a projection plane, along the height direction of the apparatus, an orthographic projection of the hollow portion on the projection plane is located within an outer contour of an orthographic projection of the top surface on the projection plane;
the apparatus further comprises a suction pump, the suction pump is configured to suck a gas in the through hole, the suction pump is in communication with the through hole; and
when the apparatus is in the first working state, at least part of the carrier is in contact with the top surface of the base, along the height direction of the apparatus, the carrier moves towards the coating assembly relative to the hollow portion.

6. The apparatus of claim 5, further comprising a conveyor device, wherein the conveyor device comprises a conveyor belt and the carrier, the conveyor belt is connected to the carrier; and
along a conveying path of the conveyor belt, at least part of the conveyor belt penetrates through the base, and the conveyor belt gives way the hollow portion of the base.

7. The apparatus of claim 5, wherein the coating device comprises a fixing seat and a connecting seat, the coating assembly is connected to the connecting seat, the connecting seat is connected to the fixing seat; along a length or width direction of the apparatus, at least part of the coating assembly and the base are located in a same side of the fixing seat;
the fixing seat comprises a first connecting portion and a second connecting portion, when the connecting seat is connected to the first connecting portion of the fixing seat, a first distance is defined between the coating assembly and the base along the height direction of the apparatus; and
when the connecting seat is connected to the second connecting portion of the fixing seat, a second distance is defined between the coating assembly and the base along the height direction of the apparatus, wherein the first distance is greater than the second distance, or the first distance is less than the second distance.

8. The apparatus of claim 5, further comprising a supporting table, wherein both the base and the fixing seat are connected to the supporting table,
the coating assembly comprises a screen frame, an ink-scraping blade and an ink-returning blade, the screen frame, the ink-scraping blade and the ink-returning blade are all connected to the connecting seat; and along the height direction of the apparatus, at least part of the ink-scraping blade and at least part of the ink-returning blade are located away from the base relative to the screen frame.

9. The apparatus of claim 2, further comprising a pre-positioning structure, wherein the pre-positioning structure is located away from the curing device relative to the coating device along a conveying path of the conveyor belt; and
the pre-positioning structure comprises a carrier seat and at least two positioning portions, the at least two positioning portions are connected to the carrier seat, the pre-positioning structure further comprises a drive structure configured to adjust positions of the at least two positioning portions, at least one of the at least two positioning portions is connected to the drive structure.

10. The apparatus of claim 2, further comprising a flipping table and at least two coating and curing units, wherein the at least two coating and curing units comprise a first coating and curing unit and a second coating and curing unit,
the coating device comprises a first coating device and a second coating device, the curing device comprises a first curing device and a second curing device, the first coating device and the first curing device are defined as the first coating and curing unit, the second coating device and the second curing device are defined as the second coating and curing unit; and
along a conveying path of the conveyor belt, the first curing device is located between the first coating device and the flipping table, the second coating device is located between the flipping table and the second curing device, the flipping table is located between the first curing device and the second coating device.

11. A method for preparing a magnetic material by using the apparatus of claim 1, comprising following steps:
providing a composite material and a magnet, wherein the composite material comprises a diffusion material and a light curing agent;
coating the composite material on at least part of a surface of the magnet; and
performing a light curing treatment on the composite material and forming a coating layer on at least part of the surface of the magnet, to obtain the magnetic material.

12. The method of claim 11, wherein the method meets at least one of following conditions:
(1) the diffusion material is one or more of heavy rare earth hydrides, heavy rare earth fluorides, heavy rare earth oxides, heavy rare earths and alloys thereof;
(2) a mass ratio of the diffusion material to the light curing agent is in a range of 3:1 to 8:1; and
(3) after performing the light curing treatment on the composite material, a weight increase percentage of two surfaces of the magnet is in a range of 0.1% to 2.0% magnet.

13. The method of claim 11, wherein
the light curing agent comprises at least one of an infrared light curing agent, a visible light curing agent, or an ultraviolet light curing agent,
wherein the visible light curing agent comprises prepolymer containing olefinic unsaturated groups of 0 to 20 wt %, monomer containing olefinic unsaturated groups of 20 wt % to 80 wt %, a photoinitiator of 1 wt % to 10 wt %, a co-initiator of 0.5 wt % to 30 wt %, an additive of 0 to 10 wt %, a filler or a pigment of 0 to 40 wt %, a solvent of 0 to 30 wt %; and
the ultraviolet light curing agent comprises epoxy acrylate of 1 wt % to 35 wt %, polyurethane acrylate of 1 wt % to 35 wt %, multi-functional acrylate monomer of 20 wt % to 50 wt %, an additive of 1 wt % to 15 wt %, a photoinitiator of 1 wt % to 10 wt %.

14. The method of claim 11, wherein
providing the composite material further comprises following steps:
making the diffusion material into powder, mixing the powder like diffusion material with the light curing agent;
coating the composite material on at least part of the surface of the magnet further comprises following steps:
coating the composite material on at least part of the surface of the magnet by at least one method of printing, spraying, roller coating, or immersion coating; and
performing the light curing treatment on he composite material further comprises following steps:
curing the composite material by at least one of near infrared light, ultraviolet light, or visible light, wherein a curing time is in a range of 0.5 s to 300 s.

15. A magnetic material prepared by the method of claim 11, wherein the magnetic material comprises a magnet and a coating layer, the coating layer is disposed on at least part of a surface of the magnet, the coating layer comprises a diffusion material and a light curing material, and the light curing material is processed by a light curing agent through a light curing treatment.

16. A method for preparing NdFeB magnet material by using the apparatus of claim 1 comprising following steps:
step (1), processing a diffusion material containing heavy rare earth elements in a powder form;
step (2), grinding a surface of the NdFeB magnet by a sandpaper until a surface of the NdFeB magnet is smooth and removing oil and dirt;
step (3), mixing the diffusion material obtained in step (1) with a light curing agent uniformly in a certain mass ratio to obtain a mixture, feeding the mixture into the printer, and printing the mixture uniformly on the surface of the NdFeB magnet obtained in step (2); and
step (4), curing the NdFeB magnet obtained in step (3) under a light source to obtain the NdFeB magnet material, wherein the light source is near infrared light, ultraviolet light, or visible light, when the light source is near infrared light, upconversion nanoparticles are added to the light curing agent before curing, a curing time is in a range of 0.5 s to 300 s.

17. The method of claim 16, further comprising step (5), under a protective atmosphere of Ar, first maintaining the NdFeB magnet obtained in step (4) at 100° C. to 500° C. for 5 min to 600 min, then performing a heat treatment at 750° C. to 1000° C. for 4 h to 20 h, and finally annealing at 400° C. to 600° C. for 0 h to 15 h.

18. The method of claim 16, wherein in step (4), the curing time is in a range of 0.5 s to 60 s; and the method further comprises:
step (5), under a protective atmosphere of Ar, first maintaining the NdFeB magnet obtained in step (4) at 400°° C. to 500°° C. for 5 min to 60 min, then performing a heat treatment at 750° C. to 1000° C. for 4 h to 10 h, and finally annealing at 400° C. to 600° C. for 2 h to 8 h, to obtain the NdFeB magnet material.

19. The method of claim 18, wherein the method meets at least one of following conditions:
(1) in step (1), the diffusion material is one or more of heavy rare earth hydrides, heavy rare earth fluorides, heavy rare earth oxides, heavy rare earths and alloys thereof;
(2) in step (3), a mass ratio of the diffusion material to the light curing agent is in a range of 3:1 to 8:1;
(3) in step (3), a weight increase percentage of two surfaces of the magnet is in a range of 0.1% to 2.0%; and
(4) in step (4), an adding concentration of the upconversion nanoparticles is in a range of 0.5% to 5%.

20. The method of claim 18, wherein
the light curing agent comprises at least one of an infrared light curing agent, a visible light curing agent, or an ultraviolet light curing agent;
wherein the visible light curing agent comprises prepolymer containing olefinic unsaturated group of 0 to 20 wt %, monomer containing olefinic unsaturated groups of 20 wt % to 80 wt %, photoinitiator of 1 wt % to 10 wt %, a co-initiator of 0.5 wt % to 30 wt %, an additive of 0 to 10 wt %, a filler or a pigment of 0 to 40 wt %, a solvent of 0 to 30 wt %; and
the ultraviolet light curing agent comprises epoxy acrylate of 1 wt % to 35 wt %, polyurethane acrylate of 1 wt % to 35 wt %, multi-functional acrylate monomer of 20 wt % to 50 wt %, an additive of 1 wt % to 15 wt %, a photoinitiator of 1 wt % to 10 wt %.
